(19) United States
(12) Patent Application Publication
(10) Pub. No.: US 2023/0373267 A1
(43) Pub. Date: Nov. 23, 2023

(54) TEMPERATURE CONTROL DEVICE

(71) Applicant: TRUMA GERAETETECHNIK GMBH & CO. KG, Putzbrunn (DE)

(72) Inventor: Timo WOLFROM, Putzbrunn (DE)

(21) Appl. No.: 18/031,033

(22) PCT Filed: Oct. 7, 2021
(86) PCT No.: PCT/EP2021/000118

§ 371 Date: Apr. 10, 2023

(30) Foreign Application Priority Data
Oct. 21, 2020 (DE) 102020006479.5

(51) Int. Cl. B60H 1/00; F04D 29/42; F04D 29/66

(52) U.S. Cl. CPC B60H 1/00521; F04D 29/4226; F04D 29/663; B60H 2001/006

(57) ABSTRACT

Example embodiments relate to a temperature control device for controlling the temperature of air. The temperature control device including a fan and a blow-out area in a housing, the fan moving air to the blow-out area, a sound wave-effective body being arranged in the blow-out area, and the sound wave-effective body being part of a compensating ring for producing an air duct adjacent to the blow-out area.

The present invention relates to a temperature control device for controlling the temperature of air. This involves, for example, an air conditioning system for cooling a room. In one variant, this involves an air conditioning system to be fastened on the roof of a vehicle (for example of a mobile home or a caravan). In one alternative variant, this involves a heating system which heats air.

In heating systems (so-called air heaters), it is known to transfer the thermal energy produced by the combustion of air, Diesel or gasoline, for example, to the air. To this end, heat exchangers, for example, through which the air to be heated passes, are often provided.

The principle of cold generation using a cooling circuit on which air cooling is based has been known for a long time and is described in document WO 2007/042065 A1, for example. Such air conditioning systems include in most cases two fans and two heat exchangers. One fan and one associated heat exchanger belong to the evaporator in which the air of the room to be cooled is cooled by interaction with the refrigerant. A further fan and an associated heat exchanger belong to the condenser in which thermal energy of the refrigerant is transferred to the ambient air and is therefore dissipated.

Due to the components used, the moved air and further resonance effects, noises often arise which may be perceived as unpleasant.

The use of sound barriers is disclosed in DE 10 2006 050 339 A1, for example.

Therefore, the object on which the invention is based is to propose a temperature control device which is characterized by reduced background noise.

The invention achieves the object by means of a temperature control device for controlling the temperature of air, the temperature control device comprising a fan and a blow-out area in a housing, the fan moving air to the blow-out area, a sound wave-effective body being arranged in the blow-out area, and the sound wave-effective body being part of a compensating ring for producing an air duct adjacent to the blow-out area.

A fan conveys air into a blow-out area via which the air exits the housing of the temperature control device. In one configuration, the blow-out area is for example coupled to an air distributor which is located in that room the air of which is to be temperature controlled, and there provides for distribution of the cooled or heated room air. A body is arranged in the blow-out area which is sound wave-effective and thus has an effect on the air with respect to arising or already produced noises. This sound wave-effective body is part of a compensating ring. Depending on the configuration, the body may be an integral part of the compensating ring or, in an alternative configuration, may be connected to a basic form of the compensating ring. The compensating ring serves to form an air duct adjacent to the blow-out area. The compensating ring thus forms an extension of the area in which the air is guided. In one variant, the compensating ring leads to the compensation for height differences when the temperature control device is fixed to a support surface (e.g. a vehicle roof) with respect to the blow-out area below the support surface (corresponding to the room below the vehicle roof). Alternatively or additionally, the compensating ring serves to seal a transition between the blow-out area and a further component which is connected to the housing or at which there is a transition from the housing to the roof or ceiling, for example. The compensating ring thus has an at least partially enclosed area in which the air from the blow-out area is guided. One advantage of the invention consists in that the assembly is simplified as no component for sound absorption has to be separately fastened or mounted. Moreover, it is thus possible to realize different variants of a temperature control device (i.e. with or without noise reduction) using the same housing.

In one configuration, the compensating ring serves as a height compensation between the housing and a room air distributor. In this configuration, different roof thicknesses, for example, may thus be taken into consideration via the compensating ring.

In one configuration, the compensating ring and at least one height compensating ring serve as a height compensation, and the compensating ring and the height compensating ring are connected to each other by geometries which latch into each other. The connection is realized by fitting into each other, for example.

According to one configuration, the sound wave-effective body is reversibly arranged in the blow-out area. As the sound wave-effective body is part of the compensating ring and the latter is brought into contact with the housing during assembly, the body may thus also be removed again.

In one configuration, the sound wave-effective body substantially has a cuboid shape.

According to one configuration, the sound wave-effective body has a greater extension in one direction than in at least one direction perpendicular thereto. Furthermore, the direction of the greater extension is substantially a direction in which the air exits the blow-out area. The longest path of interaction between the air and the body thus occurs substantially in the direction of flow. Tests have shown that such an orientation produces only small deviations of the flow with only slight changes in volume. Significant acoustic effects are simultaneously produced.

In one configuration, the sound wave-effective body is at least partially made of a temperature resistant material. In one configuration, the sound wave-effective body has a temperature resistant material at least on part of the outer surface.

According to one configuration, the sound wave-effective body is at least partially made of EPP. EPP is expanded polypropylene.

In one configuration, the sound wave-effective body has sound-absorbing properties. Thus, the body absorbs, for example, sound waves or converts the latter in kinetic energy, for example. In an alternative or additional configuration, the sound wave-effective body acts as a resonance body. In this configuration, specific frequency ranges are for example filtered out or submitted to a particular intensification or attenuation with respect to the total spectrum.

One configuration consists in that the temperature control device is configured as an air conditioning system, that the air conditioning system includes an evaporator, and that the fan moves the air through the evaporator towards the blow-out area. The refrigerant is guided through the evaporator to absorb the thermal energy of the air to be cooled by interaction with the air.

More specifically, there are a variety of possibilities of configuring and further developing the temperature control device according to the invention. To this end, reference is made, on the one hand, to the claims depending on claim 1, and, on the other hand, to the description below of example embodiments in conjunction with the drawing, in which:

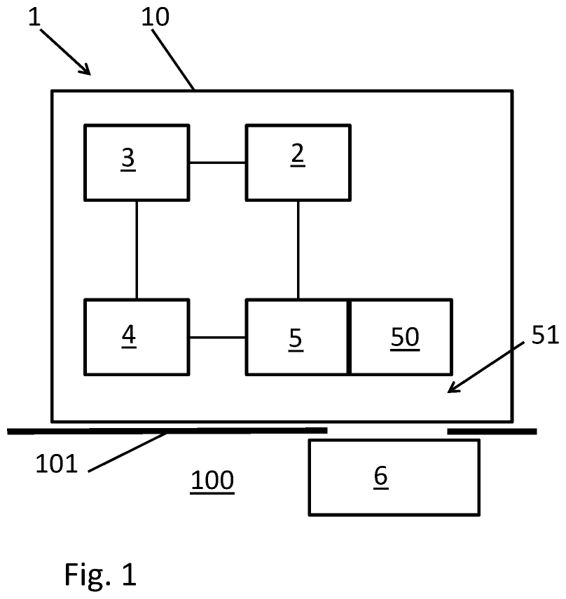

FIG. 1 shows a schematic representation of an air conditioning apparatus, and

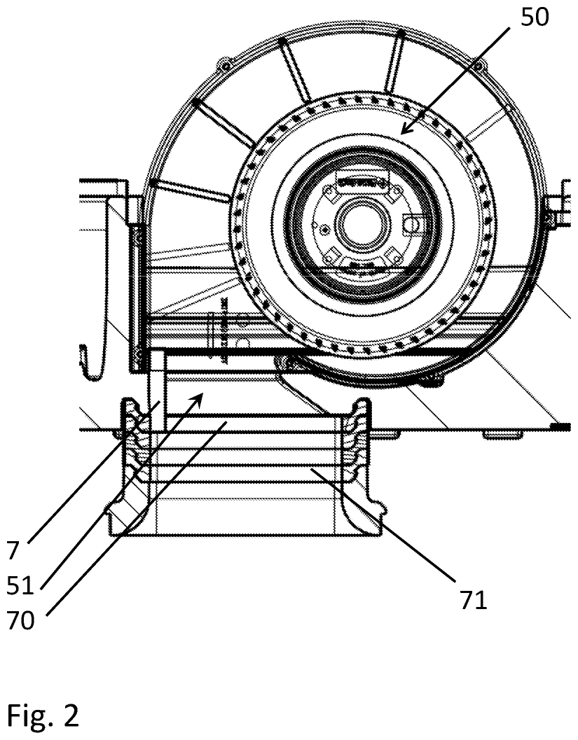

FIG. 2 shows a section through a configuration of an air conditioning system.

FIG. 1 schematically shows the structure of an air conditioning system 1 for cooling a room 100 as an example for a temperature control device. The cooling circuit or refrigeration process thus realized is described, for example, in document WO 2007/042065 A1. The room 100 is for example the interior of a caravan or a mobile home. For this case of application, the air conditioning system 1 is mounted on the vehicle roof of the caravan or mobile home.

For the refrigeration process, a compressor 2 compresses a gaseous refrigerant which is thus heated and conveyed to a condenser 3 via a refrigerant line. In the condenser 3, the heat of the refrigerant is transferred to the ambient air (or outside air) from the environment around the room 100. The outside air is thus sucked in—by an appropriate fan—and again blown out after interaction with the refrigerant in a heat exchanger. Therefore, this unit 3 may also be referred to as outside air or outdoor heat transferring means. As a result of the heat release, the compressed refrigerant condenses. The liquid refrigerant which is still under high pressure is expanded to a lower pressure in an expansion means 4, which is for example configured as a throttle. The refrigerant is thus cooled.

In the next step, the refrigerant reaches an evaporator 5, through which the room air of the room 100 to be cooled is guided by means of an evaporator fan 50. The room air thus transfers its heat to the refrigerant, which changes to the gaseous state. Thus, the component 5 may also be referred to as an interior air or indoor heat transferring means. The gaseous refrigerant finally returns to the compressor 2 so that the refrigeration cycle can continue. The cooled air is in turn distributed by the fan 50 out of the blow-out area 51 and in the room 100 through a so-called room air distributor 6. Here, in the example shown, the ceiling 101 of the room 100 is interrupted, as the housing 10 with the described components of the air conditioning system 1 is located outside the room 100 and here on the roof 101. The circuit can also be reversed so that the device 1 acts as a room heater. In this case, the condenser 3 described above acts as an evaporator and, conversely, the evaporator 5 serves as a condenser.

FIG. 2 shows a detail of a part of an air conditioning system. It shows the blow-out area 51 for the preferably cooled air into the room located below the air conditioning system. The evaporator fan 50 serves for the transport of air. An alternative designation would be indoor fan.

The cuboidal sound wave-effective body 7 can be seen, which here is formed in one piece with the upper compensating ring 70 and the longer extension of which is oriented in the direction of the air draft. The compensating ring 70 and three further height compensating rings 71 as well as an end piece therebelow define an air duct which adjoins the blow-out area 51 and opens into the room air distributor (not shown here). The height of this air duct in the assembled state depends on the height of the ceiling located between the upper housing and the lower room air distributor (see FIG. 1). The compensating ring 70 and the height compensating rings 71 are connected to each other by corresponding geometries.

### LIST OF REFERENCE NUMERALS

1 temperature control device
2 compressor
3 condenser
4 expansion means
5 evaporator
6 room air distributor
7 sound wave-effective body
10 housing
50 evaporator fan
51 blow-out area
70 compensating ring
71 height compensating ring
100 room
101 ceiling

1. A temperature control device for controlling the temperature of air, comprising:
a compensating ring,
the temperature control device being configured as an air conditioning system adapted to be fastened on a vehicle roof of a caravan or a mobile home,
wherein the air conditioning system includes an evaporator and a room air distributor,
the temperature control device including a fan and a blow-out area in a housing,
wherein the fan moving air through the evaporator to the blow-out area,
a sound wave-effective body being reversibly arranged in the blow-out area, and
wherein the sound wave-effective body is reversibly arranged in the blow-out area,
wherein the sound wave-effective body has sound-absorbing properties and/or acting as a resonance body,
wherein the sound wave-effective body is part of the compensating ring for producing an air duct adjacent to the blow-out area and opening into the room air distributor, and
wherein the compensating ring serves as a height compensation between the housing and the room air distributor.

2. The temperature control device according to claim 1,
wherein the compensating ring and at least one height compensating ring serve as a height compensation, and
wherein the compensating ring and the height compensating ring are connected to each other by geometries which latch into each other.

3. The temperature control device according to claim 1,
wherein the sound wave-effective body has a cuboid shape.

4. The temperature control device according to claim 1,
wherein the sound wave-effective body has a greater extension in one direction than in at least one direction perpendicular thereto, and
wherein the direction of the greater extension is a direction in which the air exists the blow-out area.

5. (canceled)

6. (canceled)

7. The temperature control device according to claim 4,
wherein the sound wave-effective body is at least partially made of EPP.

8. (canceled)

9. (canceled)

10. (canceled)
